(19) United States
(12) Patent Application Publication
(10) Pub. No.: US 2019/0090004 A1
(43) Pub. Date: Mar. 21, 2019

(54) COMBINED ACCESS TO NETWORK AND OUT OF NETWORK CONTENT

(71) Applicant: Layer3 TV, Inc., Denver, CO (US)

(72) Inventors: Jeffrey Binder, Denver, CO (US); Vic Odryna, Boston, MA (US); Patrick Herlihy, Boston, MA (US)

(21) Appl. No.: 16/131,720

(22) Filed: Sep. 14, 2018

Related U.S. Application Data
(60) Provisional application No. 62/558,886, filed on Sep. 15, 2017.

(51) Int. Cl. H04N 21/258; H04N 21/431; H04N 21/482

(52) U.S. Cl. CPC H04N 21/25875; H04N 21/482; H04N 21/431

(57) ABSTRACT

A content provider network device generates a user interface which can be used to access both content assets available through the content provider network and content assets available from one or more devices of one or more providers outside the content provider network. In some implementations, the user interface is generated based on collected first metadata regarding a first set of content assets available through a content provider and second metadata regarding a second set of content assets available from a device of a provider outside the content provider network. In various implementations, a selection may be received via the user interface for out of network content that requires authentication and the content provider network device may manage the authentication. In numerous implementations, the content provider network device may determine available first and second sets of content and selects a subset to base the user interface thereon.

### CROSS-REFERENCE TO RELATED APPLICATION(S)

This application is a nonprovisional patent application of and claims the benefit of U.S. Provisional Patent Application No. 62/558,886, filed Sep. 15, 2017 and titled “Combined Access to Network and Out of Network Content,” the disclosure of which is hereby incorporated herein by reference in its entirety.

### FIELD

The described embodiments relate generally to content provider networks, such as cable or satellite television provider networks. More particularly, the present embodiments relate to combined access to network and out of network content assets.

### BACKGROUND

Users may use content access devices such as set top boxes, televisions, computing devices, and so on to access a variety of different content assets from various kinds of content access networks. These content assets may include video content assets, audio content assets, image content assets, data content assets, and so on.

In some cases, users may access content assets from a content provider network. Content provider networks may provide subscribers access to content assets included in the network. Such access may be provided on the basis of various fee arrangements. Users may also be able to access content assets from sources other than the content provider network, such as via the Internet and/or other providers.

### SUMMARY

The present disclosure relates to a content provider network device that generates a user interface which can be used to access both content assets available through the content provider network and content assets available from one or more devices of one or more providers outside the content provider network. In some implementations, the content provider network device may generate the user interface by collecting first metadata regarding a first set of content assets available through a content provider and second metadata regarding a second set of content assets available from a device of a provider outside the content provider network and generating the user interface based thereon. In various implementations, a selection may be received via the user interface for a content asset available from a device of a provider outside the content provider network that requires authentication to obtain the content asset and the content provider network device may manage the authentication to obtain the content asset. In numerous implementations, the content provider network device may determine a first set of content assets available through the content provider network and a second set of content assets available from a device of a provider outside the content provider network and select a subset to base the user interface thereon.

In some embodiments, a content provider network device includes a non-transitory storage medium that stores instructions and a processing unit coupled to the non-transitory storage medium. The processing unit executes the instructions to collect first metadata regarding a first set of content assets available through a content provider network and second metadata regarding a second set of content assets available from a device of a provider outside the content provider network, generate a user interface from the first metadata and the second metadata, and receive a request to access a content asset of the first set of content assets or the second set of content assets via the user interface.

In various implementations, the processing unit determines that the user interface cannot present the content asset and directs launch of an application associated with the provider outside the content provider network to present the content asset. In some examples, the processing unit determines that the user interface cannot present the content asset, determines that the user interface cannot directly link to the content asset via launch of an application associated with the provider outside the content provider network, provides an indication of available content assets from the provider, and prompts for a selection to launch the application.

In numerous implementations, the processing unit obtains the second metadata from a content asset metadata provider outside the content provider network. In some implementations, the processing unit obtains the second metadata by web indexing the device. In various implementations, the processing unit obtains the second metadata from a media rich site summary associated with the provider. In some examples of such implementations, the processing unit further obtains the second metadata by web indexing based on the media rich site summary associated with the provider.

In various embodiments, a content provider network device includes a non-transitory storage medium that stores instructions and a processing unit. The processing unit is coupled to the non-transitory storage medium and executes the instructions to generate a user interface that provides access to a first set of content assets available through a content provider network and a second set of content assets available from a device of a provider outside the content provider network, receive a selection of a content asset of the second set of content assets, the device requiring authentication to obtain the content asset, manage the authentication to obtain the content asset, and provide the content asset to a client device. The processing unit may obtain the content asset from the device.

In some implementations, the processing unit manages the authentication by using authentication information for the content provider network to obtain the content asset. In numerous implementations, the processing unit manages the authentication by using authentication information for a user who made the selection that is stored in the non-transitory storage media to obtain the content asset. In some examples of such implementations, the authentication information for the user is associated with a service other than the provider but can be used to authenticate with the provider. In various implementations, the processing unit manages the authentication by determining the content asset can be obtained unauthenticated from an additional device and obtaining the content asset to provide to the client device from the additional device.

In numerous embodiments, a content provider network device includes a non-transitory storage medium that stores instructions and a processing unit coupled to the non-transitory storage medium that executes the instructions to determine a first set of content assets available through a content provider network and a second set of content assets available from a device of a provider outside the content provider network, select a subset of the first set of content assets and the second set of content assets, generate a user interface from the subset, and receive a request to access one of the subset via the user interface.

In some implementations, the processing unit selects the subset based on monitored information regarding how a user behaved with regard to content assets in situations that share characteristics with a current situation. In other implementations, the processing unit selects the subset based on a location of a client device to which the user interface is provided. In still other implementations, the processing unit selects the subset based on a content asset category. In yet other implementations, the processing unit selects the subset based on a current time. In various other implementations, the processing unit selects the subset by rejecting one content asset that requires a user to provide authentication information in favor of another content asset that does not require the user to provide the authentication information.

In numerous implementations, the processing unit may subsequently generate an additional user interface. In examples of such implementations, the processing unit determines to generate an additional user interface, selects a different subset of the first set of content assets and the second set of content assets, and generates the additional user interface from the different subset.

### BRIEF DESCRIPTION OF THE DRAWINGS

The disclosure will be readily understood by the following detailed description in conjunction with the accompanying drawings, wherein like reference numerals designate like structural elements.

FIG. 1 depicts an example of a content provider network system.

FIG. 2 depicts a flow chart illustrating a first example method for providing access to content. This method may be performed by the system of FIG. 1.

FIG. 3 depicts a flow chart illustrating a second example method for providing access to content. This method may be performed by the system of FIG. 1.

FIG. 4 depicts a flow chart illustrating a third example method for providing access to content. This method may be performed by the system of FIG. 1.

FIG. 5 depicts a flow chart illustrating a fourth example method for providing access to content. This method may be performed by the system of FIG. 1.

FIG. 6 depicts a first example user interface. This first example user interface may be generated by the system of FIG. 1 and/or one or more of the methods of FIGS. 2-5.

FIG. 7 depicts the first example user interface of FIG. 6 after a user device changes location.

FIG. 8 depicts a second example user interface. This second example user interface may be generated by the system of FIG. 1 and/or one or more of the methods of FIGS. 2-5.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, and computer program products that embody various elements of the present disclosure. However, it should be understood that the described disclosure may be practiced in a variety of forms in addition to those described herein.

Content provider network systems, such as cable or satellite television network systems, may allow a content provider to provide users access to content assets included in their network via content access devices, such as set top boxes, televisions, computing devices, and so on. These content assets may include video content assets, audio content assets, image content assets, data content assets, and/or any other kind of content assets. Access to the content assets may be provided as one or more linear broadcast or other streams, on demand, as part of a digital video recorder (DVR) function, and so on. The users may be required to subscribe to the content provider's network in order to access content assets included in the network.

In many situations, users may also desire to access content assets that are outside of the content. Access to such content assets may be provided by one or more video content providers, social media networks, and/or other providers that are separate from the content provider and accessible via one or more networks like the Internet. Some content access devices that may be used with some content provider networks may be unable to access content assets outside of the content provider network. Others may be able to access outside content assets, such as content assets accessible via one or more networks (such as the Internet), but may use a separate user interface (such as a web browser, a dedicated or specialized application or app, and so on) than what may be used to access in network content.

This may result in a confusing user experience due to switching between user interfaces to browse, access, and/or otherwise interact with in network and out of network content. Switching may also multiply the amount of tasks performed by content access devices and/or content provider network devices, burdening the finite resources of those devices.

The following disclosure relates to combined access to in network and out of network content. A content provider network device generates a user interface that can be used to access both content assets available through the content provider network and content assets available from one or more devices of one or more providers outside the content provider network. This may result in a more intuitive user experience due to users not needing to switch between user interfaces to browse, access, and/or otherwise interact with in network and out of network content. This may also reduce the amount of tasks performed by content access devices and/or content provider network devices, improving the operation of those devices.

In some implementations, the content provider network device may generate the user interface by collecting first metadata regarding a first set of content assets available through the content provider and second metadata regarding a second set of content assets available from a device of a provider outside the content provider network. The content provider network device may generate the user interface from the first metadata and second metadata and may receive one or more requests to access a content asset of the first set of content assets or the second set of content assets via the user interface.

The first and/or second metadata may include any kind of information describing the first and/or second sets of content assets. This information may include one or more titles, file types, durations, actors, content descriptions, source identifiers, previews, thumbnails, images, file sizes, file qualities, encoding information, file renderer information, digital rights policies, locations, and/or any other data regarding the respective content asset.

The content provider network device may collect the second metadata in a variety of ways. The second metadata may be obtained from a content asset metadata provider outside the content provider network (such as Gracenote™ or any other metadata provider), from a media rich site summary (RSS) (or other feed that describes updates to online content) associated with the provider, by web indexing or similarly “spidering” the provider or the device, and so on. For example, a list of outside provider devices may be maintained and media RSS of outside provider devices on the list may be monitored and/or the outside provider devices on the list may be web indexed at various times to obtain the second metadata. By way of another example, a media RSS of an outside provider device may be monitored to obtain the second metadata, but the outside provider device may also be web indexed based on the media RSS feed as the media RSS feed may not be entirely up to date or accurate for the outside provider device.

In various implementations, a selection may be received via the user interface for a content asset available from a device of a provider outside the content provider network that requires authentication to obtain the content asset. In such a situation, the content provider network device may manage the authentication to obtain the content asset. The content provider network device may then provide the content asset to a client device.

For example, the content provider network device may store authentication information (such as a login and password) for a user who made the selection and may provide the stored authentication information to the device to obtain the requested content asset without requiring user interaction. In some cases of such an example, the authentication may be for a service, provider, and so on other than the provider or device associated with the requested content asset but can be used to authenticate with the provider. For example, a video content provider may allow authentication using Facebook™ authentication information, which the content provider network device may have stored and use. By way of another example, the content provider network may be authorized to obtain the content asset from the device. As such, the content provider network device may use authentication information for the content provider network to obtain the requested content asset. In still other examples, the content provider network device may determine that the device requires authentication for the requested content asset but that the requested content asset can be obtained unauthenticated from an additional device. In such a situation, the content provider network device may obtain the requested content asset to provide to the client device from the additional device.

The content provider network device may provide a client device access to a requested content asset from a device of a provider outside the content provider network in various ways. In some examples, the content provider network device may obtain the requested content asset from the device and transmit the obtained content asset to the client device. In other examples, the content provider network device may request the device transmit the requested content asset to the client device, provide the client device information that may be used to pull the content asset from the device, and so on.

In numerous implementations, the content provider network device may determine a first set of content assets available through the content provider network and a second set of content assets available from a device of a provider outside the content provider network. The content provider network device may select a subset of the first set of content assets and the second set of content assets and generate the user interface from the subset.

The content provider network device may select the subset of the first and second sets of content assets based on a variety of different criteria and conditions. For example, the content provider network device may select the subset of the first and second sets of content assets based on monitored information regarding how a user behaved with regard to content assets in previous situations. The previous situations may share one or more characteristics with a current situation. Characteristics may include times, locations, other accessed content, and so on. As a result, the user interface may present the user with the ability to request content assets that are most relevant to the user out of the first and second sets of content assets.

By way of another example, the content provider network device may select the subset based on a location of a client device to which the user interface is provided. For example, certain content assets may only be authorized for access when a user accesses content from a network connected to their home. As such, the content provider network device may select the subset as including the certain content when the client device is located at the user's home and not including the certain content when the client device is located elsewhere.

By way of yet another example, the content provider network device may select the subset based on a content asset category. For example, the content provider network device may be operable to generate user interfaces that include movie content assets, television content assets, on demand content assets, stored recording content assets, action programming content assets, family rated content assets, content assets recommended for a particular user, currently airing content assets, content assets shared by a user's friends or other connections on one or more social media networks, and so on. Content assets may be classified according to any number of different categories and corresponding user interfaces may be generated accordingly.

In still another example, the content provider network device may select the subset based on a current time. For example, the content provider network device may select a first subset if the current time is before 5:00 PM and a second subset if the current time is 5:00 PM or after.

In yet another example, the content provider network device may select the subset based on authentication requirements. For example, the content provider network device may select the subset by excluding or rejecting one content asset that requires the user to provide user authentication information in favor of another content asset that does not require the user to provide user authentication information. This may reduce the chances that the user would be burdened with having to provide additional authentication information.

In various examples, the content provider network device may be operable to provide user interfaces including different subsets selected from the first and second set of content assets. For example, the content provider network device may select a first subset and generate a user interface accordingly, determine to generate an additional user interface, select a different subset, and generate the additional user interface from the different subset. In this way, the content provider network device may be operable to generate any number of different user interfaces that provide different views of the content assets that are available to a user. This may provide the user an increased ability to locate content assets and/or reduce the amount of navigation (and thus the amount of content provider network or other device resources to enable that navigation) needed to locate content assets.

In some implementations, content assets requested via the user interface may be presented by the user interface or an associated presentation user interface. However, in some situations, the requested content asset may be one that is available from the device of the provider outside the content provider network and is not able to be presented by the user interface or the associated presentation user interface. For example, the user interface or the associated presentation user interface may not be compatible with the requested content asset, may not have permissions to present the requested content asset, and so on. Instead, the content provider device may determine that presentation cannot be performed and may direct launch of an application or app associated with the provider outside the content provider network and/or the content asset. In some situations, launch of the application or app may directly link to the content asset and thus result in presentation of the content asset by the application or app. In other situations, direct linking to the content asset may not be possible or feasible. As such, an indication of content assets available via the application or app and/or from the provider may be made and a prompt may be made for a selection to generally launch the application or app.

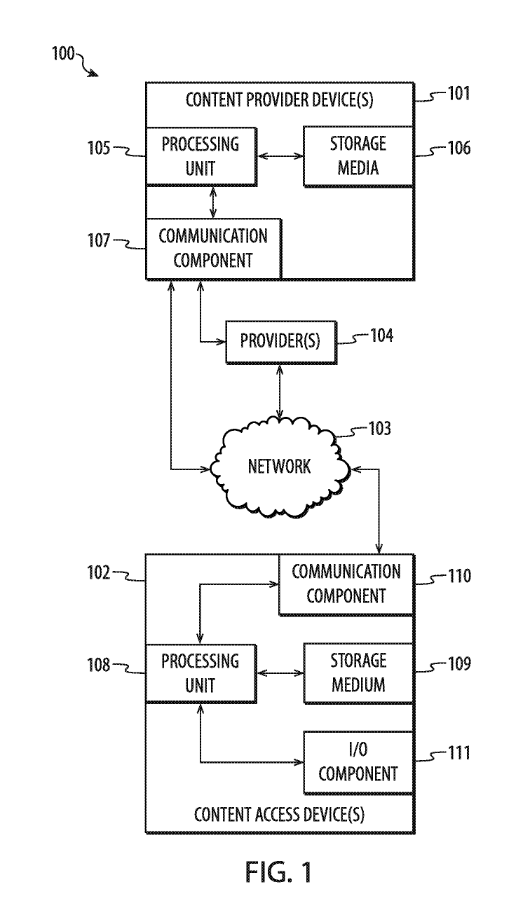

These and other embodiments are discussed below with reference to FIGS. 1-8. However, those skilled in the art will readily appreciate that the detailed description given herein with respect to these Figures is for explanatory purposes only and should not be construed as limiting.

FIG. 1 depicts an example of a content provider network system 100. The system 100 may include one or more content provider devices 101, content access devices 102, and/or one or more provider devices 104 communicably connected via one or more communication networks 103. The content provider device 101 may be operable to generate a user interface that may be provided to the content access device 102. The user interface may be used to access both content assets available through the content provider network and content assets available from one or more provider devices 104 outside the content provider network. In numerous implementations, the content provider device 101 may determine a first set of content assets available through the content provider network and a second set of content assets available from a provider device 104 outside the content provider network and may select a subset of the first set of content assets and the second set of content assets from which to generate the user interface.

In some implementations, the content provider device 101 may generate the user interface by collecting first metadata regarding a first set of content assets available through the content provider and second metadata regarding a second set of content assets available from a provider device 104 outside the content provider network. In various implementations, a selection may be received via the user interface for a content asset available from a provider device 104 outside the content provider network that requires authentication to obtain the content asset. In such a situation, the content provider device 101 may manage the authentication to obtain the content asset.

These content assets may include a variety of different content assets that may be available via a variety of different content provider network and out of network sources. The content assets may include video content assets, audio content assets, image content assets, data content assets, and so on. The sources may include, but are not limited to, video provider services (such as Netflix™, Amazon Prime™, and so on), content assets shared publicly or by friends or other connections on social media networks (such as Facebook™, Twitter™, Tumblr™, LinkedIn™, and so on), other content provider networks, and so on. As the user interface may enable access to content assets from a variety of different sources, the content provider device 101 may be aware of and have access to these various entities and/or accounts with which the user of the user interface has a relationship. As such, the content provider device 101 may be able to provide access to such, indicate what is available at such (which may be specific to the user), manage authentication information for the user (such as by storing provided authentication information for the user), and so on.

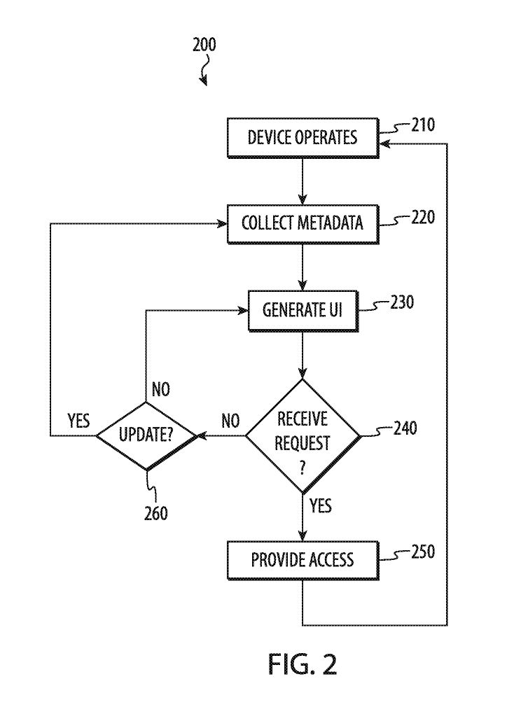

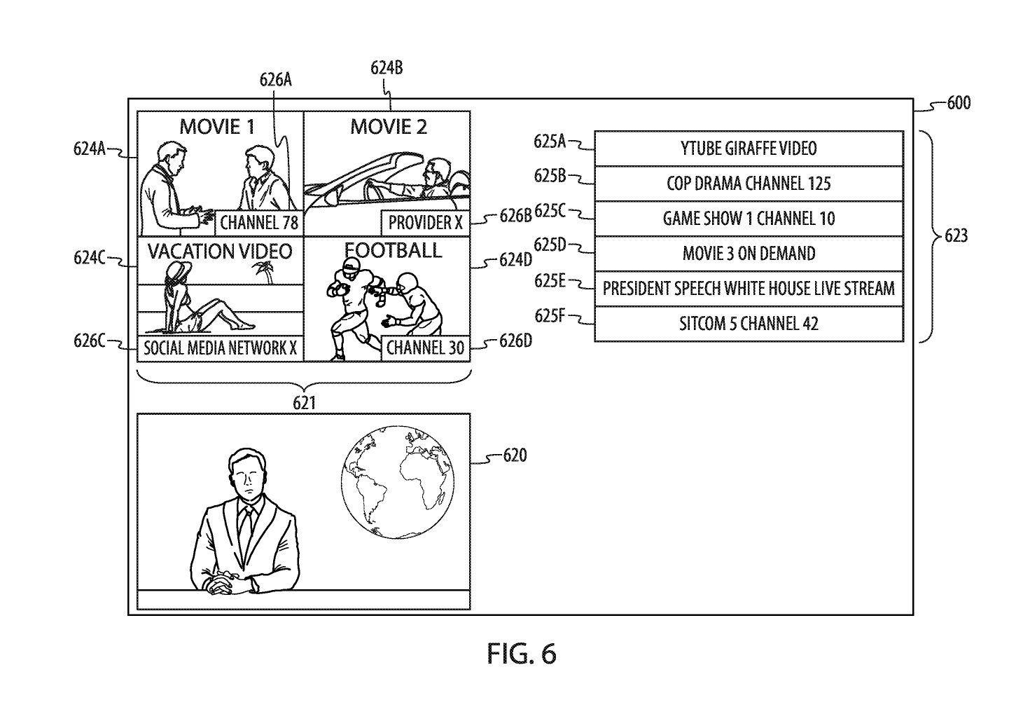

The content provider device 101 may include one or more processing units 105, one or more non-transitory storage media 106 (which may take the form of, but is not limited to, a magnetic storage medium; optical storage medium; magneto-optical storage medium; read only memory; random access memory; erasable programmable memory; flash memory; and so on), one or more communication components 107, and/or other components. The processing unit 105 may execute one or more instructions stored in the non-transitory storage medium 106 to perform various functions. Such functions may include generating user interfaces (such as the example user interfaces 600 and 800 discussed below and shown in FIGS. 6-8), obtaining metadata, determining available content, communicating with the provider device 104 and/or the content access device 102, obtain content, manage authentication, select subsets of content and/or metadata, present content, direct presentation of content, direct launch of other applications or apps, and so on. Such functions may also include performance of various methods, such as the example methods 200-500 discussed below and shown in FIGS. 2-5.

Similarly, the content access device 102 (which may be one or more set top boxes, computing devices, cellular telephones, tablet computing devices, digital media players, wearable devices, mobile computing devices, and so on) may include one or more processing units 108, one or more non-transitory storage media 109, one or more communication components 110, input/output components 111 (such as one or more displays, speakers, printers, microphones, and so on), and/or other components. The processing unit 108 may execute one or more instructions stored in the non-transitory storage medium 109 to perform various functions. Such functions may include receiving user interfaces, presenting user interfaces, transmitting user interface selections and/or requests for content assets, presenting content assets, receiving content assets, communicating with the content provider device 101 and/or the provider device 104, and so on.

FIG. 2 depicts a flow chart illustrating a first example method 200 for providing access to content. This first example method 200 may be performed by the system 100 of FIG. 1.

At 210, a device operates. The flow proceeds to 220 where the device collects metadata. The metadata may be first metadata regarding a first set of content assets available through a content provider network and second metadata regarding a second set of content assets available from a device of a provider outside the content provider network. The second metadata may be obtained from a content asset metadata provider, from a media RSS associated with the provider, by web indexing, a combination thereof, and so on. Next, the flow proceeds to 230 where the device generates a user interface from the metadata.

The flow then proceeds to 240 where the device determines whether or not a request to access a content asset represented in the user interface is received. If so, the flow proceeds to 250. Otherwise, the flow proceeds to 260.

At 250, after the device determines a request to access a content asset represented in the user interface is received, the device provides access to the content based on the request. Providing access may involve obtaining and transmitting the content asset, directing another device to transmit the content asset, providing information another device may use to pull or otherwise request the content, and so on.

At 260, after the device determines a request to access a content asset represented in the user interface is not received, the device determines whether or not to update the user interface. If not, the flow returns to 230 where the device continues to provide the user interface. Otherwise, the flow returns to 220 where the device again collects metadata for generating a user interface.

Although the first example method 200 is illustrated and described as including particular operations performed in a particular order, it is understood that this is an example. In various implementations, various orders of the same, similar, and/or different operations may be performed without departing from the scope of the present disclosure.

For example, the first example method 200 is illustrated and described as providing access to a requested content asset at 250. However, it is understood that this is an example. In some implementations, the device may perform one or more additional operations.

By way of example, in some implementations, the device may determine that the device cannot provide access to the requested content asset via the user interface. For example, the requested content asset may be obtained from a provider outside of a content provider network of the device. The device may instead direct launch of an application associated with the provider of the content asset outside of the content provider network to present the content. For example, the content asset may be provided by Netflix™ and the device may direct launch of a Netflix™ app to present the content.

In still other examples, the device may determine that the device cannot directly link to the requested content asset via launch of an application associated with the provider of the content asset outside of the content provider network. Instead, the device may provide an indication of available content assets from that provider, which may include the requested content asset, and may prompt for a selection to launch the application. This may still allow the user to launch the application and then navigate in that application to access the requested content asset.

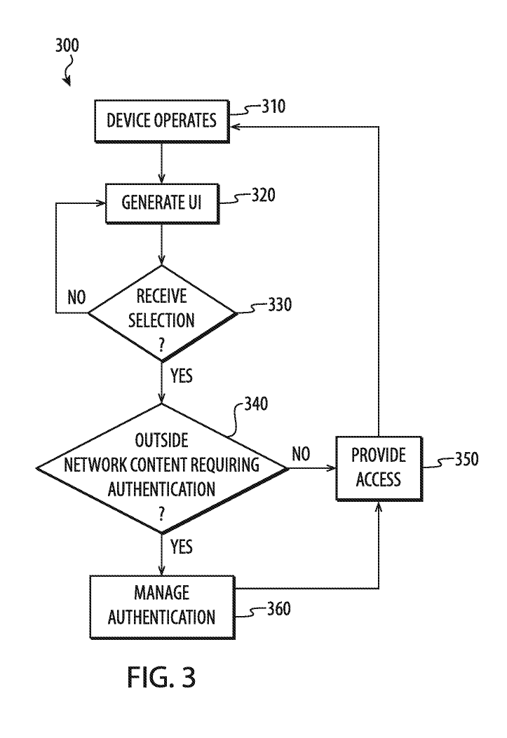

FIG. 3 depicts a flow chart illustrating a second example method 300 for providing access to content. This second example method 300 may be performed by the system 100 of FIG. 1.

At 310, a device operates. The flow proceeds to 320 where the device generates a user interface. The user interface may provide access to content assets included in a content provider network and content assets located on devices maintained by providers outside the content provider network.

The flow then proceeds to 330 where the device determines whether or not a selection of a content asset from the user interface is received. If not, the flow returns to 320 where the device continues to provide the user interface. Otherwise, the flow proceeds to 340.

At 340, the device determines whether or not the requested content asset is outside network content that requires authentication. If not, the flow proceeds to 350 where the device provides access before the flow returns to 310 and the device continues to operate. Otherwise, the flow proceeds to 360 where the device manages authentication for the requested content asset before the flow proceeds to 350 where access to the requested content asset is provided.

Although the second example method 300 is illustrated and described as including particular operations performed in a particular order, it is understood that this is an example. In various implementations, various orders of the same, similar, and/or different operations may be performed without departing from the scope of the present disclosure.

For example, the second example method 300 is illustrated and described as managing authentication for the requested content asset. However, in some implementations, the device may be able to manage authentication for some requested content assets but not others. In such implementations, the device may manage authentications when possible and may prompt for authentication information from a user when the device is not able to manage authentication.

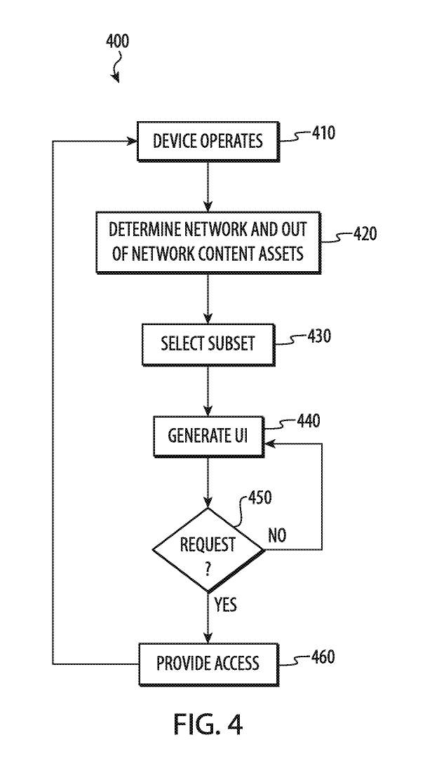

FIG. 4 depicts a flow chart illustrating a third example method 400 for providing access to content. This third example method 400 may be performed by the system 100 of FIG. 1.

At 410, a device operates. The flow proceeds to 420 where the device determines in network and out of content provider network content assets. The flow then proceeds to 430 where the device selects a subset of the determined content assets before the flow proceeds to 440 where the device generates a user interface based on the selected subset.

The device may select the subset of in network and out of network content assets based on a variety of different criteria and conditions, such as based on monitored information regarding how a user behaved with regard to content assets in previous situations sharing one or more characteristics with a current situation, based on a location of a client device to which the user interface is provided, based on a content asset category, based on a current time, based on rejecting content assets that require authentication information to be provided in favor of content assets that do not, and so on.

Next, the flow proceeds to 450 where the device determines whether or not a request for a content asset from the user interface is received. If not, the flow returns to 440 where the device provides access before the flow returns to 440 and the device continues to provide the user interface. Otherwise, the flow proceeds to 460 where the device provides access before the flow returns to 410 and the device continues to operate.

Although the third example method 400 is illustrated and described as including particular operations performed in a particular order, it is understood that this is an example. In various implementations, various orders of the same, similar, and/or different operations may be performed without departing from the scope of the present disclosure.

For example, the third example method 400 is illustrated and described as selecting a single subset and then generating the user interface based thereon. However, in various implementations, the device may select different subsets from which to generate different user interfaces without departing from the scope of the present disclosure.

As discussed above, the device may select the subset of the first and second sets of content assets based on a variety of different criteria and conditions. In some implementations, the device may select the subset based on monitored information regarding how a user behaved with regard to content assets in previous situations. The previous situations may or may not share one or more characteristics with a current situation. Characteristics may include times, locations, other accessed content, and/or any other characteristics. As a result, the user interface may present the user with the ability to request content assets that are most relevant to the user.

For example, monitored information may indicate that a user watched football 80% of the evening hours, but only during football season. Outside of football season, the user may have watched a particular television network 70% of the evening hours. As such, a football program may be included in the user interface during football season whereas the particular television network may be included outside of football season.

In another example, monitored information may indicate that a user only requests content assets from an out of network fee-based movie service on Friday and Saturday evenings and instead uses in network free on demand options otherwise. If it is Friday or Saturday evening, content assets from the out of network fee-based movie service may be included in the user interface. Otherwise, in network free on demand content assets may be included.

By way of another example, monitored information may indicate that a user watched R rated movies only in the user's bedroom and family comedies in the user's living room. As such, family comedies may be included in the user interface when presented on a content access or other client device in the user's living room whereas R rated movies may be included when presented by a content access or other client device in the user's bedroom.

In yet another example, monitored information may indicate that a user accesses a dating social media network only in the user's bedroom and a work social media network in the user's office. As such, content assets from the work social media network may be included in the user interface when presented on a content access or other client device in the user's office whereas content assets from the dating social media may be included when presented by a content access or other client device in the user's bedroom.

In another example, monitored information may indicate that a user views local news in the morning and national news in the afternoon. If the user accesses the user interface in the morning, local news content assets from the news channel may be included. However, if the user accesses the user interface in the evening, national news content assets from the news channel may be included.

In still another example, monitored information may indicate that a user views Internet videos in the morning and friends' pictures on a social media network in the afternoon. If the user accesses the user interface in the morning, content assets from Internet video servers may be included. However, if the user accesses the user interface in the evening, picture content assets from the user's friends on the social media network may be included.

In various examples, monitored information may indicate that user behavior is dependent on a context such as time. For instance, a user may always watch local XYZ news at 7:00 AM. When it is 7:00 AM, the user interface may therefore include local XYZ news in a manner that makes it convenient for the user to choose to watch it.

However, even when context includes a time of day, time may not be the sole consideration. Context may be more than only the time of day. Context may also depend on the location in which content is being accessed. For example, content assets a user usually accesses in their family room may be different from what they usually access in their home theater, kitchen, bedroom, and so on. Many other factors beyond a current time and/or location might be taken into account in determining which content assets to include in the user interface. For example, weather may be a consideration. If there is an approaching storm, weather content assets may be included.

Another example may be a sporting event to a sporting enthusiast. If a sporting enthusiast user accesses the user interface during March Madness and a National Collegiate Athletic Association game is currently airing, the game may be included in the user interface. Similar actions may be performed in relation to when World Cup soccer is happening.

Yet another example may be a breaking news item. If the user is an avid news follower, a news program may be included if a breaking news item has occurred. Occurrences such as storms, breaking news items, and other events that may influence context may be determined in a variety of ways. For example, occurrences may be detected from social media feeds, such as the user's social media feed, national and/or other trending topics lists, and so on; various social media posts; manual entry by one or more content providers; and so on.

In various implementations, the device may select the subset based on a location of a client device to which the user interface is provided. In other implementations, the device may select the subset based on a category. Content assets may be classified according to any number of different categories (different profiles for a user so that the user can be presented with different options for different situations like family viewing or private viewing situations, movies, television, currently available, popular, suggested for the current user, free, on demand, provided by a particular provider, source, and so on) and corresponding user interfaces may be generated accordingly. In still other implementations, the content provider network device may select the subset based on a current time and/or location of the client device used to which the user interface is provided.

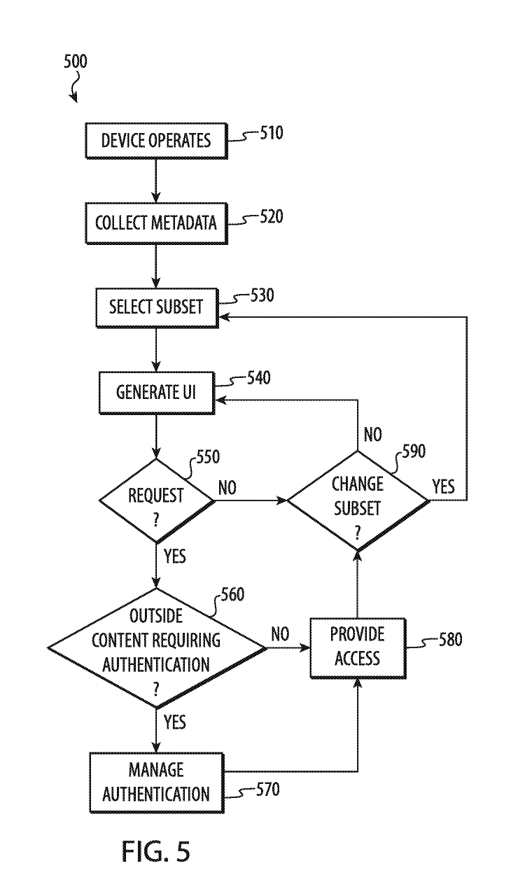

FIG. 5 depicts a flow chart illustrating a fourth example method 500 for providing access to content. This fourth example method 500 may be performed by the system 100 of FIG. 1.

At 510, a device operates. The flow proceeds to 520 where the device collects first metadata regarding a first set of content assets available through a content provider network and second metadata regarding a second set of content assets available from a device of a provider outside the content provider network. Next, the flow proceeds to 530 where the device selects a subset of the first and second sets of content assets. The flow then proceeds to 540 where the device generates a user interface based on the subset.

Next, the flow proceeds to 550 where the device determines whether or not a selection of a content asset from the user interface is received. If so, the flow proceeds to 560. Otherwise, the flow proceeds to 590.

At 560, the device determines whether or not the requested content asset is a content asset outside of a content provider network that requires authentication. If not, the flow proceeds to 580 where the device provides access before the flow proceeds to 590. Otherwise, the flow proceeds to 570 where the device manages authentication for the requested content asset before the flow proceeds to 580 where access to the requested content asset is provided.

At 590, after the device determines a selection from the user interface has not been received, the device determines whether or not to change the subset. If not, the flow returns to 540 where the device continues to provide the user interface. Otherwise, the flow returns to 530 where the device selects a different subset.

Although the fourth example method 500 is illustrated and described as including particular operations performed in a particular order, it is understood that this is an example. In various implementations, various orders of the same, similar, and/or different operations may be performed without departing from the scope of the present disclosure.

For example, the fourth example method 500 is illustrated and described as including 520 where first and second metadata is collected. However, in other implementations, the device may determine a first set of content assets available through a content provider network and a second set of content assets available from a device of a provider outside the content provider network without collecting metadata.

Further, although the example methods 200-500 illustrated and described with respect to FIGS. 2-5 show various combinations of the techniques discussed herein, it is understood that these are examples. Various aspects of the example methods 200-500 illustrated and described with respect to FIGS. 2-5 and/or other techniques discussed in the present application may be combined in a variety of ways without departing from the scope of the present disclosure. Various configurations are possible and contemplated.

FIG. 6 depicts a first example user interface 600. This first example user interface may be generated by the system 100 of FIG. 1 and/or one or more of the methods 200-500 of FIGS. 2-5. In this implementation, the first example user interface 600 includes a primary field 620 including an indicator corresponding to content assets determined to be most relevant to a user, a secondary field 621 including indicators 624A-624D corresponding to content assets determined to be next most relevant to a user, and a tertiary field 623 including indicators 625A-625F corresponding to content assets determined to be still next most relevant to a user.

The indicator of the primary field 620 may present a news content asset currently being broadcast in a content provider network associated with the first example user interface 600. The indicator 624A may include a still image and text identifying a “Movie 1” content asset currently being broadcast associated with a channel 78 of a content provider network, which may be identified by an included identifier 626A. The indicator 624B may include a still image and text identifying a “Movie 2” content asset that can be obtained from an out of network video “Provider X,” which may be identified by an included identifier 626B. The indicator 624C may include a still image and text identifying an out of network “Vacation Video” content asset shared on a “Social Media X” by a social media connection of the user, which may be identified by an included identifier 626C. The indicator 624D may include a still image and text identifying a “Football” content asset currently being broadcast associated with a channel 30 of a content provider network, which may be identified by an included identifier 626D.

Similarly, the indicator 625A may include text identifying an out of network “Giraffe Video” content asset available from a “Ytube” video provider site. The indicator 625B may include text identifying a “Cop Drama” content asset currently being broadcast associated with a channel 125 of the content provider network. The indicator 625C may include text identifying a “Game Show” content asset currently being broadcast associated with a channel 10 of the content provider network. The indicator 625D may include text identifying a “Movie 3” content asset available as on demand content from the content provider network. The indicator 625E may include text identifying a live streaming “President's Speech” content asset currently being live streamed by an out of network “White House” live streaming service. The indicator 625F may include text identifying a “Sitcom 5” content asset currently being broadcast associated with a channel 42 of the content provider network.

Thus, as shown, the first example user interface 600 may include representations related to a variety of different content provider network content assets and out of network content assets associated with a variety of different kinds of content providers. The representations may be selected by a user to request the associated content asset. Further, as shown, the respective content assets may be depicted in a variety of different ways (video, images, text, size and/or position of indicators, and so on) based on relative importance, the type and/or source of content asset, and so on.

Although the first example user interface 600 is illustrated and described as configured in a particular manner with particular elements, it is understood that this is purely for example. In various implementations, user interfaces could be configured in a variety of different ways without departing from the scope of the present disclosure.

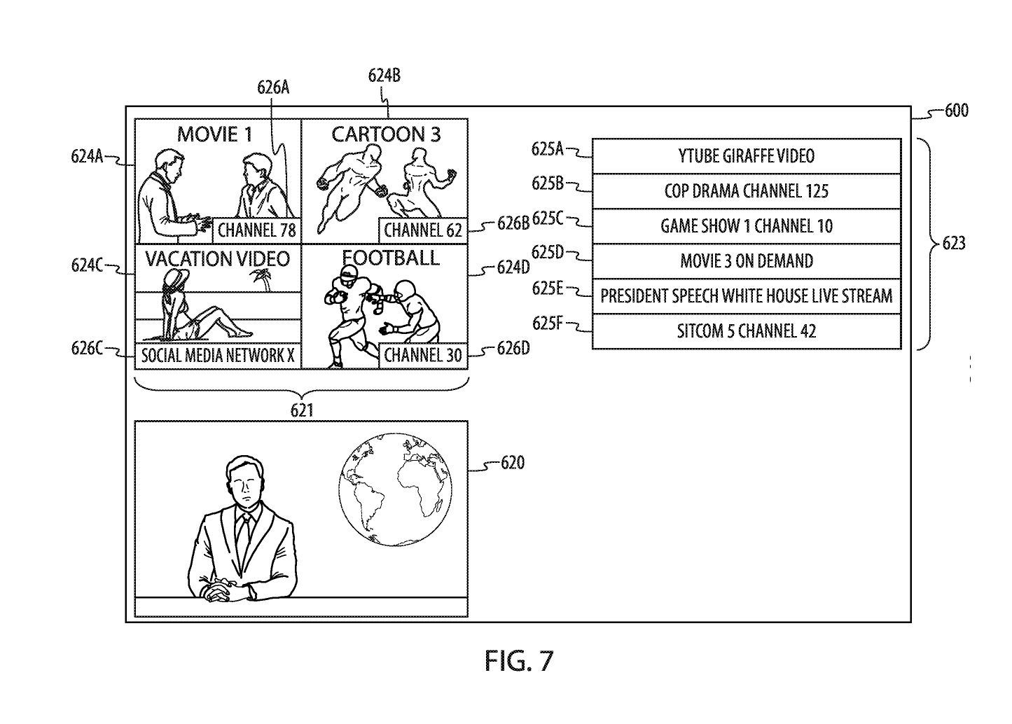

For example, in some implementations, the components of the first example user interface 600 illustrated in FIG. 6 may depend on location of a user device to which the first example user interface 600 is provided. In one example, content assets from Provider X may only be available due to contractual obligations from a user's home and FIG. 6 may depict the first example user interface 600 when the user device is located at the user's home. However, FIG. 7 depicts the first example user interface 600 of FIG. 6 after a user device changes location. As the user device is not located at the user's home, the Movie 2 content asset is unavailable. As such, the indicator 624B may be replaced with a still image and text identifying a “Cartoon 3” asset currently being broadcast associated with a channel 62 of content provider network, which may be identified by the included identifier 626B.

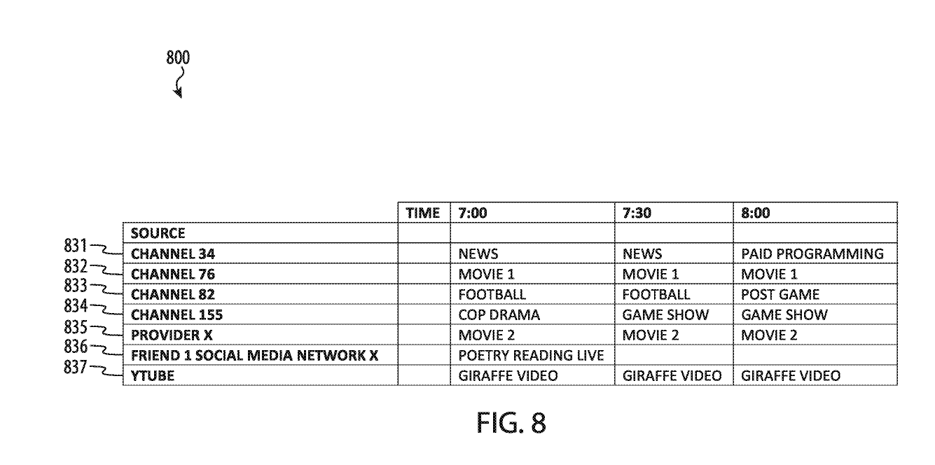

FIG. 8 depicts a second example user interface 800. This second example user interface 800 may be generated by the system of FIG. 1 and/or one or more of the methods 200-500 of FIGS. 2-5.

The second example user interface 800 may be configured as a grid organized by time and source. The second example user interface 800 may include representations of program-based and linearly broadcast content provider network content assets that are selectable to access the respective content asset. Indicator 831 indicates a source associated with a channel 34 of a content provider network which broadcasts a first “News” content asset from 7:00-7:30, a second “News” content asset from 7:30-8:00, and a “Paid Programming” content asset at 8:00. Indicator 832 indicates a source associated with a channel 76 of a content provider network which broadcasts a “Movie 1” content asset from 7:00 to at least 8:30. Indicator 833 may indicate a source associated with a channel 82 of a content provider network which broadcasts a “Football” content asset from 7:00-8:00 and a “Post Game” content asset at 8:00. Indicator 834 may indicate a source associated with a channel 155 of a content provider network which broadcasts a “Movie 1” content asset from 7:00 to at least 8:30.

The second example user interface 800 may also include representations of out of network content assets that may or may not be program-based and linearly broadcast despite the time-focused configuration of the second example user interface 800. Indicator 835 indicates a source associated with a “Provider X” video provider that offers a “Movie 2” content asset. This is shown as available at all times as the “Movie 2” content asset is available for access in its entirety any time a user requests. Indicator 836 indicates a source associated with a “Friend 1” of a “Social Media Network X” that is currently (the current time being 7:00) providing “Poetry Reading Live” live video content asset. The 7:30 and 8:00 times are blank because the live video content asset is not program-based and it is unknown how long the live video will be provided. Indicator 837 indicates a source associated with a “Ytube” Internet video provider that offers a “Giraffe Video” content asset. This is shown as available at all times as the “Giraffe Video” content asset is available for access in its entirety any time a user requests.

As such, many different kinds of in network and out of network program-based, linearly broadcast, non-program-based, non-linearly broadcast, and other content assets may be included in a time/source grid-configured user interface in a variety of different ways despite their dissimilarity to content assets that such a time/source grid-configured user interface may have been originally designed. Various configurations are possible and contemplated.

Further, although the example user interfaces 600 and 800 of FIGS. 6-8 are illustrated and described as configured in particular arrangements and representing particular types and/or instances of content assets, it is understood that these are for the purpose of example and are not intended to be limiting. In various implementations, user interfaces may be configured in a variety of different arrangements and represent varies types and/or instances of content assets provided via a variety of different sources without departing from the scope of the present disclosure. Various configurations are possible and contemplated without departing from the scope of the present disclosure.

As described above and illustrated in the accompanying figures, the present disclosure relates to a content provider network device that generates a user interface which can be used to access both content assets available through the content provider network and content assets available from one or more devices of one or more providers outside the content provider network. In some implementations, the content provider network device may generate the user interface by collecting first metadata regarding a first set of content assets available through the content provider and second metadata regarding a second set of content assets available from a device of a provider outside the content provider network and generating the user interface based thereon. In various implementations, a selection may be received via the user interface for a content asset available from a device of a provider outside the content provider network that requires authentication to obtain the content asset and the content provider network device may manage the authentication to obtain the content asset. In numerous implementations, the content provider network device may determine a first set of content assets available through the content provider network and a second set of content assets available from a device of a provider outside the content provider network and select a subset to base the user interface thereon.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A content provider network device, comprising:
a non-transitory storage medium that stores instructions; and
a processing unit coupled to the non-transitory storage medium that executes the instructions to:
collect first metadata regarding a first set of content assets available through a content provider network and second metadata regarding a second set of content assets available from a device of a provider outside the content provider network;
generate a user interface from the first metadata and the second metadata; and
receive a request to access a content asset of the first set of content assets or the second set of content assets via the user interface.

2. The content provider network device of claim 1, wherein the processing unit:
determines that the user interface cannot present the content asset; and
directs launch of an application associated with the provider outside the content provider network to present the content asset.

3. The content provider network device of claim 1, wherein the processing unit:
determines that the user interface cannot present the content asset;
determines that the user interface cannot directly link to the content asset via launch of an application associated with the provider outside the content provider network;
provides an indication of available content assets from the provider; and
prompts for a selection to launch the application.

4. The content provider network device of claim 1, wherein the processing unit obtains the second metadata from a content asset metadata provider outside the content provider network.

5. The content provider network device of claim 1, wherein the processing unit obtains the second metadata from a media rich site summary associated with the provider.

6. The content provider network device of claim 5, wherein the processing unit further obtains the second metadata by web indexing based on the media rich site summary associated with the provider.

7. The content provider network device of claim 1, wherein the processing unit obtains the second metadata by web indexing the device.

8. A content provider network device, comprising:
a non-transitory storage medium that stores instructions; and
a processing unit coupled to the non-transitory storage medium that executes the instructions to:
generate a user interface that provides access to a first set of content assets available through a content provider network and a second set of content assets available from a device of a provider outside the content provider network;
receive a selection of a content asset of the second set of content assets, the device requiring authentication to obtain the content asset;
manage the authentication to obtain the content asset; and
provide the content asset to a client device.

9. The content provider network device of claim 8, wherein the processing unit manages the authentication by using authentication information for the content provider network to obtain the content asset.

10. The content provider network device of claim 8, wherein the processing unit manages the authentication by using authentication information for a user who made the selection that is stored in the non-transitory storage medium to obtain the content asset.

11. The content provider network device of claim 10, wherein the authentication information for the user is associated with a service other than the provider but can be used to authenticate with the provider.

12. The content provider network device of claim 8, wherein the processing unit manages the authentication by:
determining the content asset can be obtained unauthenticated from an additional device; and
obtaining the content asset to provide to the client device from the additional device.

13. The content provider network device of claim 8, wherein the processing unit obtains the content asset from the device.

14. A content provider network device, comprising:
a non-transitory storage medium that stores instructions; and
a processing unit coupled to the non-transitory storage medium that executes the instructions to:
determine a first set of content assets available through a content provider network and a second set of content assets available from a device of a provider outside the content provider network;
select a subset of the first set of content assets and the second set of content assets;
generate a user interface from the subset; and
receive a request to access one of the subset via the user interface.

15. The content provider network device of claim 14, wherein the processing unit selects the subset based on monitored information regarding how a user behaved with regard to content assets in situations that share characteristics with a current situation.

16. The content provider network device of claim 14, wherein the processing unit selects the subset based on a location of a client device to which the user interface is provided.

17. The content provider network device of claim 14, wherein the processing unit selects the subset based on a content asset category.

18. The content provider network device of claim 14, wherein the processing unit selects the subset based on a current time.

19. The content provider network device of claim 14, wherein the processing unit selects the subset by rejecting one content asset that requires a user to provide authentication information in favor of another content asset that does not require the user to provide the authentication information.

20. The content provider network device of claim 14, wherein the processing unit:
determines to generate an additional user interface;
selects a different subset of the first set of content assets and the second set of content assets; and
generates the additional user interface from the different subset.
